(19) United States
(12) Patent Application Publication
(10) Pub. No.: US 2019/0233781 A1
(43) Pub. Date: Aug. 1, 2019

(54) PLURALITIES OF WATER-SOLUBLE ARTICLES AND RELATED PROCESSES

(71) Applicant: The Procter & Gamble Company, Cincinnati, OH (US)

(72) Inventors: Sun-Jan Alan HUANG, Cincinnati, OH (US); Mark Robert SIVIK, Mason, OH (US); Frank William DENOME, Cincinnati, OH (US)

(21) Appl. No.: 16/253,255

(22) Filed: Jan. 22, 2019

Related U.S. Application Data
(60) Provisional application No. 62/622,160, filed on Jan. 26, 2018.

(51) Int. Cl. C11D 17/04; D04H 3/05; D04H 3/018; D06M 23/08

(52) U.S. Cl. CPC C11D 17/042; D04H 3/05; D06M 13/005; D06M 23/08; D04H 3/018

(57) ABSTRACT

Water-soluble unit dose articles that include fibrous elements. First and second articles that differ with regard to compositional and physical features. Processes for making such articles.

### FIELD OF THE INVENTION

The present disclosure relates to pluralities water-soluble unit dose articles and processes for making such articles. The articles may contain fibrous elements, and may differ with regard to compositional and physical features.

### BACKGROUND OF THE INVENTION

Providing consumer products in water-soluble unit dose form is becoming increasingly popular, in part due to the convenient, no-mess form. In particular, water-soluble articles that include fibrous elements may be particularly advantageous. For example, active agents can be loaded into or onto the fibrous elements themselves, be entangled with them, be coated onto the elements, or deposited onto a ply made from such elements. Further, articles may include two or more plies, which can increase the flexibility and/or effectiveness of the form. Additionally, articles made from fibrous elements may have a relatively content of the active ingredient(s), content, as water or other solvents may not be required at significant levels.

A further advantage of the form is that different articles can be loaded with different types or levels of active agents in order to provide different benefit profiles. However, when presented with a variety of articles, the consumer may become confused as to which article to use for which job or at which time. For example, in a laundry context, it may be disastrous to use an article that includes a bleaching agent to wash denim blue jeans; it may be inefficient to provide an article that includes a quaternary softening agent to a wash cycle of an automatic washing machine; it may be desirable to wash the laundry loads of certain members of the family with articles that contain one perfume and the loads of other members with a different perfume, or perhaps no perfume at all for sensitivity reasons. The possibility of selection confusion may be particularly acute with regard to water-soluble fibrous articles, giving that they are a relatively new and unfamiliar form, especially when the variety of articles are provided in a single container.

It is desirable to provide unit dose articles, particularly those containing fibrous elements as described herein, in a manner that reduces such user confusion.

### SUMMARY OF THE INVENTION

The present disclosure relates to water-soluble unit dose articles and processes for making such articles. The articles may include at least a first ply, the first ply comprising a plurality of fibrous elements, each fibrous element comprises at least one filament-forming material and, optionally, a surfactant.

More specifically, the present disclosure relates to a plurality of water-soluble unit dose articles, the plurality including at least a first article and a second article, where the plurality includes a compositional difference between the first and second articles, and where the plurality includes a physical difference between the first and second articles.

The present disclosure also relates to a process for treating a surface, the process including the steps of contacting the surface with water in which a first water-soluble unit dose article has been dissolved and contacting the surface with water in which a second water-soluble unit dose article has been dissolved, where the first and second articles are characterized by a compositional difference, and where the first and second articles are characterized by a physical difference.

### BRIEF DESCRIPTION OF THE DRAWINGS

The figures herein are illustrative in nature and are not intended to be limiting.

FIG. 1 shows a perspective view of a water-soluble unit dose article according to the present disclosure.

FIG. 2 shows a top view of a water-soluble unit dose article according to the present disclosure.

FIG. 3 shows a cross-sectional view of a unit dose article according to the present disclosure, the article having two plies.

FIG. 4 shows a cross-sectional view of a unit dose article according to the present disclosure, the article having two plies, where each ply includes two layers.

FIG. 5 shows a cross-sectional view of a unit dose article according to the present disclosure, the article having three plies.

FIG. 6 shows a plurality of unit dose articles having different sizes.

FIG. 7 shows a plurality of unit dose articles having different shapes.

FIG. 8 shows a plurality of unit dose articles having different colors.

FIG. 9 shows a plurality of unit dose articles having different, complementary graphical indicia.

FIG. 10 shows a plurality of unit dose articles having different graphical indicia.

FIG. 11 shows a container comprising a plurality of unit dose articles.

FIG. 12 shows a process of making and cutting a water-soluble web to form unit dose articles.

### DETAILED DESCRIPTION OF THE INVENTION

The present disclosure relates to water-soluble unit dose articles and methods of making such articles. In particular, the present disclosure relates to pluralities of unit dose articles that have compositional and physical differences. The physical differences can act as cues to help the consumer differentiate between the articles and their respective intended uses.

Such differentiation may be important when one or more of the articles contain active agents that are particularly suitable for a particular use, when others do not. Similarly, certain articles may contain active agents that are particularly unsuitable for a particular use, so a physical difference can serve as a useful cue to the user.

It may be advantageous to use certain articles in combination with each other. Such combinatorial use may be simultaneous; for example, a user may combine articles having two different perfume mixtures to create a customized scent experience. Additionally or alternatively, combinatorial use of the articles may be sequential; for example, a user may use one article in a washing step and a different article in a conditioning step (e.g., shampoo and conditioner, or laundry detergent and fabric softener). When it is desirable to use two or more articles having different active agents in combination, physical differences in the articles can provide cues that the articles are intended to be used together, for example via shape, color, and/or graphical indicia.

The articles and processes are described in more detail below.

As used herein, the articles “a” and “an” when used in a claim, are understood to mean one or more of what is claimed or described. As used herein, the terms “include,” “includes,” and “including” are meant to be non-limiting. The compositions of the present disclosure can comprise, consist essentially of, or consist of, the components of the present disclosure.

The terms “substantially free of” or “substantially free from” may be used herein. This means that the indicated material is at the very minimum not deliberately added to the composition to form part of it, or, preferably, is not present at analytically detectable levels. It is meant to include compositions whereby the indicated material is present only as an impurity in one of the other materials deliberately included. The indicated material may be present, if at all, at a level of less than 1%, or less than 0.1%, or less than 0.01%, or even 0%, by weight of the composition.

As used herein the phrase “fabric care composition” includes compositions and formulations designed for treating fabric. Such compositions include but are not limited to, laundry cleaning compositions and detergents, fabric softening compositions, fabric enhancing compositions, fabric freshening compositions, laundry prewash, laundry pretreat, laundry additives, spray products, dry cleaning agent or composition, laundry rinse additive, wash additive, post-rinse fabric treatment, ironing aid, unit dose formulation, delayed delivery formulation, detergent contained on or in a porous substrate or nonwoven sheet, and other suitable forms that may be apparent to one skilled in the art in view of the teachings herein. Such compositions may be used as a pre-laundering treatment, a post-laundering treatment, or may be added during the rinse or wash cycle of the laundering operation.

As used herein, the phrase “water-soluble” means a material that is miscible in water. In other words, it means a material that is capable of forming a stable (does not separate for greater than 5 minutes after forming the homogeneous solution) homogeneous solution with water at ambient conditions. As used herein, “ambient conditions” as used herein means 23° C.±1.0° C. and a relative humidity of 50%±2%.

As used herein, “tessellated” and “tiled” (including derivations of each word, such as “tessellatable” and/or “tilable”) may be used interchangeably.

Unless otherwise noted, all component or composition levels are in reference to the active portion of that component or composition, and are exclusive of impurities, for example, residual solvents or by-products, which may be present in commercially available sources of such components or compositions.

All temperatures herein are in degrees Celsius (° C.) unless otherwise indicated. Unless otherwise specified, all measurements herein are conducted at 20° C. and under the atmospheric pressure.

In all embodiments of the present disclosure, all percentages are by weight of the total composition, unless specifically stated otherwise. All ratios are weight ratios, unless specifically stated otherwise.

It should be understood that every maximum numerical limitation given throughout this specification includes every lower numerical limitation, as if such lower numerical limitations were expressly written herein. Every minimum numerical limitation given throughout this specification will include every higher numerical limitation, as if such higher numerical limitations were expressly written herein. Every numerical range given throughout this specification will include every narrower numerical range that falls within such broader numerical range, as if such narrower numerical ranges were all expressly written herein.

### Water-Soluble Unit Dose Articles

The present disclosure relates to water-soluble unit dose articles, including a plurality of such articles. The plurality may include at least a first article and a second article. The plurality may comprise a compositional difference between the first and second articles. The plurality may comprise a physical difference between the first and second articles. The articles and differences between them are described in more detail below.

Articles of the present disclosure may be useful for treating a surface. Suitable surfaces to be treated may include hard surfaces (i.e., kitchen countertops, bath tubs, toilets, toilet bowls, sinks, floors, walls, teeth, cars, windows, mirrors, dishes) and/or soft surfaces (i.e., fabric, hair, skin, carpet, crops, plants).

The article 1 may be a consumer product, such as a product useful for household care and/or personal care. Household care products may include fabric care compositions and hard surface care compositions, including dish care compositions. Personal care products may include hair care compositions, oral care compositions, and skin care compositions.

FIG. 1 shows a perspective view of a representative water-soluble unit dose article 1. The article 1 may include a first surface 2 and a second surface 4 that is opposite the first surface 2. The first surface 2 and/or the second surface 4 may each be independently substantially planar in an X-Y plane. The article 1 as a whole may be substantially planar, e.g., in the X-Y plane. The X-Y plane may be determined as the plane of the article having the first and second largest dimensions (e.g, the longest and widest dimensions of the article).

The article 1 may have a perimeter 6 in an X-Y plane. The article may have a thickness 8 in a Z direction, where the Z direction is orthogonal to the X-Y plane.

The article 1 may include at least a first ply 10. The first ply comprises a plurality of fibrous elements 20. As described in more detail below, the fibrous elements may comprise at least one filament-forming material and optionally a surfactant. The article 1 may include no more than one ply.

The article may include a second ply 12. The first ply 10 may be joined to the second ply 12. Although not shown in FIG. 1, the article 1 may include a third ply 14 or even additional plies.

The article 1 may include a flange 16. The flange 16 may be located at the perimeter 6 of the article 1. The flange 16 may be continuous or discontinuous around the article 1, preferably continuous. The flange 16 may be a remnant of the manufacturing process, for example, from where the article 1 was cut from a web 100. Additionally or alternatively, the flange 16 may be an edge seal where a first ply 10 is joined with at least a second ply 12.

The flange 16/edge seal can have an edge seal breadth of from about 0.5 mm to about 4 mm or any value therebetween. Thus, in certain examples, the edge seal can have an edge seal breadth from about 0.8 mm to about 3.5 mm; from about 1 mm to about 3 mm; from about 1.2 mm to about 2.8 mm; from about 1.5 mm to about 2.5 mm; or from about 1.6 mm to about 2 mm In one example, the edge seal can have an edge seal breadth of about 1.7 mm Edge seal breadth measurements are taken in accordance with the Edge Seal Breadth Test Method described herein.

Articles 1 according to the present disclosure may exhibit a basis weight of less than 5000 g/m² as measured according to the Basis Weight Test Method described herein. The article 1 may exhibit a basis weight of greater than 10 g/m² to about 5000 g/m² and/or greater than 10 g/m² to about 3000 g/m² and/or greater than 10 g/m² to about 2000 g/m² and/or greater than 10 g/m² to about 1000 g/m² and/or greater than 20 g/m² to about 800 g/m² and/or greater than 30 g/m² to about 600 g/m² and/or greater than 50 g/m² to about 500 g/m² and/or greater than 300 g/m² to about 3000 g/m² and/or greater than 500 g/m² to about 2000 g/m² as measured according to the Basis Weight Test Method.

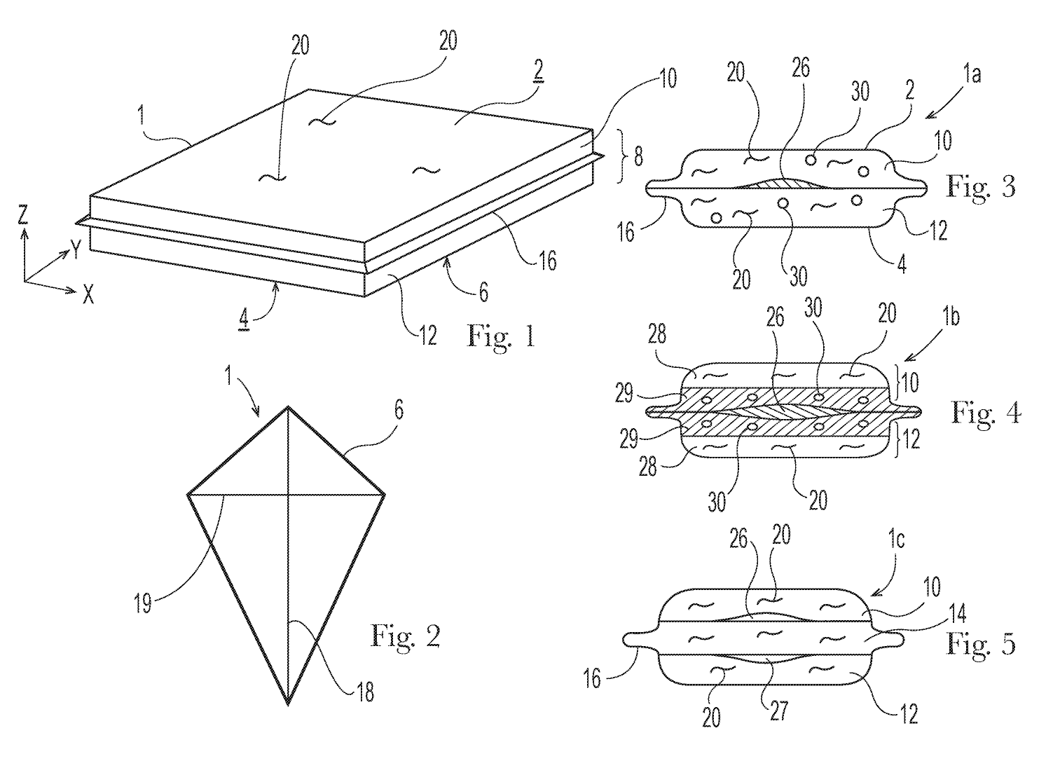

FIG. 2 shows a top view of a water-soluble unit dose article 1 according to the present disclosure. The article 1 may have a perimeter 6 in the X-Y plane. The perimeter 6 may define a shape.

As shown in exemplary fashion in the article of FIG. 2, the article 1 may be characterized by a length 18, where the length 18 is defined as the greatest dimension of the article 11 in the X-Y plane. Each article may be characterized by a width 19, where the width 19 is defined as the greatest dimension in a direction that is in the X-Y plane and is orthogonal to the length 18.

The article 1 may be sized and dimensioned to be conveniently held or otherwise handled in a one-handed fashion by an adult.

The article 1 may have a length 18 of from about 1 cm, or from about 2 cm, or from about 3 cm, or from about 4 cm, or from about 5 cm, to about 20cm, or to about 18 cm, or to about 15 cm, or to about 12 cm, or to about 8 cm. The article 1 may have length 18 of from about 5 cm to about 10 cm.

The article 1 may have a width 19 of from about 1 cm, or from about 2 cm, or from about 3 cm, or from about 4 cm, to about 12 cm, or to about 10 cm, or to about 8 cm. The article 1 may have a width 19 of from about 4 cm to about 8 cm.

A ratio of a length 18 of an article 1 to its width 19 can be from about 3:1 to about 1:1; from about 5:2 to about 1:1; or from about 2:1 to about 1:1; or from about 3:2 to about 1:1.

The article 1 can have a height, or thickness 8, from about 1 mm, or from about 2 mm, or from about 3 mm, to about 20 mm, or to about 15 mm, or to about 10 mm, or to about 7 mm. The thickness 8 may be less than about 20%, or less than about 10%, or less than about 5% of the length. The thickness 8 may be at least about 1%, or at least about 3%, or at least about 5%, of the length 18. Height, or thickness 8, measurements are taken in accordance with the Thickness Test Method described herein.

As mentioned above, the article 1 may have a perimeter 6 in an X-Y plane. The flange 16 may substantially parallel the perimeter 6. Because the flange 16 may be where multiple plies 10, 12 are joined together, the seal area and/or flange 16 may suffer from dissolution challenges. Therefore, it may be preferred to select articles 1 that have shapes with relatively minimal perimeters.

That being said, it is still important to maximize the size of the article 1 (e.g., in order to deliver a desired amount of active agents) and/or select shapes that are tessellateable (e.g., in order to efficiently manufacture the articles). The area of the shape defined by the perimeter 6 of the article 1 can be used as a proxy for the size of the article. Thus, it may be advantageous to select an article shape having a desirable ratio of perimeter 6 to area of the shape defined by the perimeter 6.

For example, the article 1 may have a length 18 (i.e., the longest dimension) of no greater than 15 cm, or no greater than 12 cm, or no greater than 10 cm, optionally the length being no less than 3 cm, no less than 4 cm, or no less than 5 cm, or no less than 6 cm, and a ratio of the perimeter to the area of the shape defined by the perimeter (“perimeter:area ratio”) in the range of from 3:10/cm, or from 4:10/cm, to no greater than 12:10/cm, or no greater than 10:10/cm, or no greater than 8:10/cm, or no greater than 6:10/cm. By way of example, an article having a perimeter in the shape of a square that is 10 cm on each side has a perimeter of 40 cm, an area of 100 cm², and a perimeter:area ratio of 0.4/cm (40 cm/100 cm²=4:10/cm, or 0.4/cm). Without wishing to be bound by theory, when the perimeter:area ratio is too high (e.g., above 1.2/cm), it is believed that there is relatively too much perimeter/edge seal for the size of the article, meaning that the dissolution issues may overshadow the performance benefits. When the perimeter:area ratio is too low (e.g., less than 0.3/cm, or less than 0.4/cm), the article may become too unwieldy to conveniently handle; in short, it may be too large for a convenient unit dose operation. For similar reasons, it may be desirable to cap the length at a maximum (e.g., less than 20, less than 18, less than 15, less than 12 cm) so that the article may be conveniently used.

The article 1 can have a volume of from about 0.25 cubic centimeters (cc) to about 60 cc; from about 0.5 cc to about 60 cc; from about 0.5 cc to about 50 cc; from about 1 cc to about 40 cc; from about 1 cc to about 30 cc; from about 2 cc to about 20 cc; from about 3 cc to about 20 cc; from about 4 cc to about 15 cc; or from about 4 cc to about 10 cc. In certain examples, the article can have a volume of from about 3 cc to about 6 cc. In other examples, the article can have a volume of from about 20 cc to about 35 cc; or from about 24 cc to about 30 cc.

The article 1 can have a mass of about 50 g or less; about 40 g or less; about 30 g or less; about 25 g or less; about 20 g or less; about 15 g or less; about 10 g or less; about 7.5 g or less; about 5 g or less; about 4 g or less; about 3 g or less; about 2 g or less; about 1.5 g or less; about 1.25 g or less; about 1 g or less; about 0.75 g or less; or about 0.5 g or less. In certain examples, the article can have a mass of from about 0.25 g to about 50 g; from about 0.25 g to about 40 g; from about 0.25 g to about 30 g; from about 0.25 g to about 25 g; from about 0.25 g to about 20 g; from about 0.5 g to about 15 g; from about 0.5 g to about 10 g; from about 0.5 to about 5 g; from about 0.5 g to about 4 g; from about 0.5 g to about 3 g; from about 0.5 g to about 2.5 g; or from about 1 g to about 2 g. In certain examples, the article can have a mass of from about 5 g to about 15 g; or from about 8 g to about 12 g.

FIG. 3 shows a cross-section of a water-soluble unit dose article 1a according to the present disclosure. The article 1a includes a first ply 10 and a second ply 12. The article 1a includes a flange 16 where the first and second plies 10, 12 are joined. Each ply 10, 12 includes a plurality of fibrous elements 20. One or both plies 10, 12 may also include a plurality of particles 30. The article 1a may include an interior region 26 where the first ply 10 faces the second ply 12. The interior region 26 may be in the form of a cavity and may include active ingredients. Additionally or alternatively, the interior region 26 may be where the first ply 10 contacts the second ply 12. Active ingredients may be applied to one or both plies 10, 12 in a manner, for example as a coating, so as to be located in the interior region 26 of the article 1a.

FIG. 4 shows a cross-section of a water-soluble unit dose article 1b according to the present disclosure. The article 1b includes a first ply 10 and a second ply 12. One or both plies 10, 12 may include more than one layer, for example a first layer 28 and a second layer 29. The first layer 28 may face the exterior environment. The second layer 29 may face the interior region 26. At least one of the layers, for example the first layer 28, may comprise the plurality of fibrous elements 20. Each layer 28, 29 may comprise the plurality of fibrous elements 20. At least one of the layers, for example the second layer 29, may comprise a plurality of particles 30.

FIG. 5 shows a cross-section of a water-soluble unit dose article 1c according to the present disclosure. The article 1c includes a first ply 10, a second ply 12, and a third ply 14. Each ply 10, 12, 14 includes a plurality of fibrous elements 20. As shown in FIG. 7, the article 1m may include interior regions 26, 27 between the plies 10, 12, 14.

The plies 10, 12, 14 of the water-soluble article 1 can be viewed hierarchically starting from the form in which the consumer interacts with the water soluble article 1 and working backward to the raw materials from which the plies 10, 12, 14 are made. The plies 10, 12, fibrous elements 20, and components thereof are described in more detail below.

Plies/Fibrous Structures

The plies 10, 12 may be in the form of fibrous structures that comprise one or more fibrous elements 20. The fibrous elements 20 can be associated with one another, for example being entangled and/or laid down in non-woven fashion, to form a fibrous structure. Fibrous structures can include particles within and/or on the structure. Fibrous structures can be homogeneous, layered, unitary, zoned, or as otherwise desired, with different active agents defining the various aforesaid portions.

A fibrous structure can comprise one or more layers 28, 29, the layers together forming the ply 10, 12. A ply 10, 12 having a plurality of layers 28, 29 can be formed by depositing a plurality of fibrous elements 20 having a distinguishing characteristic to form a first layer and then depositing a second layer of fibrous elements on top of the first layer.

A fibrous structure can comprise a plurality of identical or substantially identical from compositional perspective of fibrous elements. Optionally, the fibrous structure may comprise two or more different fibrous elements. Non-limiting examples of differences in the fibrous elements may be physical differences such as differences in diameter, length, texture, shape, rigidness, elasticity, and the like; chemical differences such as crosslinking level, solubility, melting point, glass transition temperature, active agent, filament-forming material, color, level of active agent, basis weight, level of filament-forming material, presence of any coating on fibrous element, biodegradable or not, hydrophobic or not, contact angle, and the like; differences in whether the fibrous element loses its physical structure when the fibrous element exposed to conditions of intended use; differences in whether the fibrous element's morphology changes when the fibrous element is exposed to conditions of intended use; and differences in rate at which the fibrous element releases one or more of its active agents when the fibrous element is exposed to conditions of intended use. In one example, two or more fibrous elements and/or particles within the fibrous structure may comprise different active agents.

The fibrous structure may exhibit different regions, such as different regions of basis weight, density and/or caliper, surface texture, pattern of fibrous structure, embossing pattern, apertures, apertures in a pattern, and the like.

The plies/fibrous structure of the present invention may be used as is or may be coated with one or more active agents.

Fibrous Elements

The plies 10, 12 and/or fibrous structures may be comprise fibrous elements 20. The fibrous elements may be water soluble. The fibrous elements 20 may include one or more filament forming materials, one or more active agents such surfactant, or combinations thereof. The active agents may be releasable from the fibrous elements, such as when the fibrous element and/or fibrous structure comprising the fibrous element is exposed to conditions of intended use. Fibrous elements that include an active agent, such as a surfactant, are preferred, as such elements provide more efficient loading of active agents and less formulation space lost to filament forming materials and/or carriers. Surfactant may be particularly preferred due to the cleaning benefits it can provide.

The fibrous elements can comprise from about 5% to about 95%, or more than 50%, by weight on a dry fibrous element basis and/or dry fibrous structure basis, of one or more filament-forming materials. The fibrous elements can comprise from about 5% to about 95%, or more than 50%, by weight on a dry fibrous element basis and/or dry fibrous structure basis, of one or more active agents, such as surfactant.

The fibrous elements may be meltblown fibrous elements, spunbond fibrous elements, hollow fibrous elements, or the like. The fibrous elements may be hydrophilic or hydrophobic. The fibrous elements may be surface treated and/or internally treated to change the inherent hydrophilic or hydrophobic properties of the fibrous element. The fibrous elements can have a diameter of less than about 100 μm and/or less than about 75 μm and/or less than about 50 μm and/or less than about 25 μm and/or less than about 10 μm and/or less than about 5 μm and/or less than about 1 μm as measured according to the Diameter Test Method described herein. The fibrous elements can have a diameter from about 1 μm to about 500 μm, optionally about 1 μm to about 1.00 μm, optionally about 1 μm to about 50 μm, optionally about 1 μm to about 30 μm, optionally about 5 μm to about 15 μm, optionally about 7 μm to about 15 μm according to the Diameter Test Method described herein. The fibrous elements can have a diameter of greater than about 1 μm as measured according to the Diameter Test Method described herein. The smaller the diameter the faster the rate of release of the active agents and the rate of loss and or altering of the fibrous element's 30 physical structure.

The fibrous element may comprise an active agent within the fibrous element and an active agent on an external surface of the fibrous element, such as an active agent coating on the fibrous element. The active agent on the external surface of the fibrous element may be the same or different from the active agent present in the fibrous element. If different, the active agents may be compatible or incompatible with one another.

The one or more active agents may be uniformly distributed or substantially uniformly distributed throughout the fibrous element. The active agents may be distributed as discrete regions within the fibrous element. The at least one active agent can be distributed uniformly or substantially uniformly throughout the fibrous element and at least one other active agent is distributed as one or more discrete regions within the fibrous element. Optionally, at least one active agent is distributed as one or more discrete regions within the fibrous element and at least one other active agent is distributed as one or more discrete regions different from the first discrete regions within the fibrous element.

Filament-Forming Material

The fibrous elements may comprise one or more filament-forming material. The filament-forming material may be any suitable material, such as a polymer or monomers capable of producing a polymer that exhibits properties suitable for making a filament, such as by a spinning process. The filament-forming material may be synthetic or naturally derived.

The filament-forming material may comprise a polar solvent-soluble material, such as an alcohol-soluble material and/or a water-soluble material, preferably a water-soluble material, which can be beneficial for product applications that include use of water. The filament-forming material may comprise a non-polar solvent-soluble material.

The filament-forming material may comprise a water-soluble material and be substantially free (less than 5% and/or less than 3% and/or less than 1% and/or 0% by weight on a dry fibrous element basis and/or dry fibrous structure basis) of water-insoluble materials.

The filament-forming material may comprise a polymer selected from the group consisting of: polymers derived from acrylic monomers such as the ethylenically unsaturated carboxylic monomers and ethylenically unsaturated monomers, polyvinyl alcohol and/or copolymers thereof, polyvinylformamide, polyvinylamine, polyacrylates, polymethacrylates, copolymers of acrylic acid and methyl acrylate, polyvinylpyrrolidones, polyalkylene oxides, starch and starch derivatives, pullulan, gelatin, and cellulose derivatives (for example, hydroxypropylmethyl celluloses, methyl celluloses, carboxymethy celluloses). The filament-forming material may comprise polyvinyl alcohol, polyvinyl alcohol copolymers, starch, starch derivatives, cellulose derivatives, or mixtures thereof.

Active Agents

The fibrous elements may comprise one or more active agents. One or more active agents may also be present in or on a ply/fibrous structure, and/or in a particle. Active agents are a class of additives that are designed and intended to provide a benefit to something other than the fibrous element and/or particle and/or fibrous structure itself, such as providing a benefit to an environment external to the fibrous element and/or particle and/or fibrous structure. For example, the active agent may be selected to provide a benefit to a surface in need of treatment.

Suitable active agents are discussed in more detail below with regard to “compositional differences,” and the fibrous elements of the present disclosure may comprise any of those listed below. In particular, the fibrous elements may comprise surfactant, such as a sulfonated surfactant (e.g., linear alkyl benzene sulfonate, or “LAS”).

One or more active agents may be released from the fibrous element and/or particle and/or fibrous structure when the fibrous element and/or particle and/or fibrous structure is exposed to a triggering condition, for example exposure to water. The fibrous elements may be water-soluble and may release the one or more active agents when solubilized in water. When the article is used to treat fabrics or hard surfaces, the triggering condition may occur in a wash or other treatment liquor, for example in an automatic washing machine, or as part of a pretreatment step. When the article is used as a personal care product, the triggering condition may occur in a bathing, showering, hand-washing, or other body-washing context.

Extensional Aids

The fibrous elements may comprise extensional aids. Non-limiting examples of extensional aids can include polymers, other extensional aids, and combinations thereof. High molecular weight extensional aids can be used since they have the ability to increase extensional melt viscosity and reduce melt fracture.

Non-limiting examples of polymers that can be used as extensional aids may include alginates, carrageenans, pectin, chitin, guar gum, xanthum gum, agar, gum arabic, karaya gum, tragacanth gum, locust bean gum, alkylcellulose, hydroxyalkylcellulose, carboxyalkylcellulose, and mixtures thereof. Nonlimiting examples of other extensional aids can include modified and unmodified polyacrylamide, polyacrylic acid, polymethacrylic acid, polyvinyl alcohol, polyvinylacetate, polyvinylpyrrolidone, polyethylene vinyl acetate, polyethyleneimine, polyamides, polyalkylene oxides including polyethylene oxide, polypropylene oxide, polyethylenepropylene oxide, and mixtures thereof.

Particles

The articles 1 of the present disclosure may comprise particles 30. “Particle” as used herein means a solid additive, such as a powder, granule, encapsulate, microcapsule, and/or prill. The particles may exhibit a median particle size of 2000 μm or less as measured according to the Median Particle Size Test Method described herein. The particle may exhibit a median particle size of from about 1 μm to about 2000 μm, from about 1 μm to about 1600 μm, from about 1 μm to about 800 μm, from about 5 μm to about 500 μm, from about 10 μm to about 300 μm, from about 10 μm to about 100 μm, from about 10 μm to about 50 μm, and/or from about 10 μm to about 30 μm as measured according to the Median Particle Size Test Method described herein. The shape of the particle can be in the form of spheres, rods, plates, tubes, squares, rectangles, discs, stars, fibers or have regular or irregular random forms.

The particles may comprise particles of the same type (e.g., including the same one or more active agents) or of different types (e.g., particles that include different active agents). The particles may be soluble or insoluble in water; the article may comprise both soluble particles and insoluble particles. The particles may be core-in-shell encapsulates.

The particles may comprise one or more active agents; suitable active agents are described below. The particles may be friable and may release an active agent when broken.

The one or more active agents of the particles may comprise a surfactant, such as an anionic surfactant. The particle may comprise a sulfated anionic surfactant, such as alkyl ethoxylated sulfate (AES). The surfactant of the particle may be different from the surfactant of the fibrous elements. For example, the particle may comprise AES surfactant, and the fibrous elements may comprise alkyl benzene sulfonate, preferably linear alkyl benzene sulfonate (LAS). Providing different surfactants may be advantageous with regard to the cleaning profile and/or the dissolution profile of the article 1.

The one or more active agents of the particles may comprise a polymer. The polymer may be a nitrogen-containing polymer, such as a polyalkyleneimine polymer, preferably a polyethyleneimine (PEI) polymer. The polymer may be alkoxylated, preferably ethoxylated and/or propoxylated. The polymer may be an ethoxylated PEI polymer, which may be optionally also propoxylated. Such polymers may improve the cleaning profile of the particles and the articles that comprise them. The polymers may also provide viscosity benefits to a particle-forming composition. Suitable polymers include PEI600 EO20 (ex BASF SE).

The one or more active agents of the particles may comprise perfume; the particles may be perfume encapsulates. The one or more active agents of the particles may comprise enzymes; the particles may comprise enzyme prills.

One or more plies of an article may comprise the particles. The particles may be entrapped by a plurality of the fibrous elements. A fibrous element may comprise a particle; for example, the particle may be stuck to the fibrous element. The particles may be located on a surface of a ply 10, for example as a coating. The particles may be located between plies 10, 12, for example in an interior space between plies 10, 12. The particles may be provided as a particle slurry and may be deposited onto the article 1, onto a ply 10, 12, 14, or may be combined with the fibrous elements 20 as the fibrous elements are deposited onto an endless surface.

Third Article

The plurality of articles may further include at least a third article. The third article may substantially be constructed as the articles described above. For example, the third article may comprise at least a first ply, the first ply comprising a plurality of fibrous elements, each fibrous element comprises at least one filament-forming material and, optionally, a surfactant.

The third article may be compositionally different from the first and/or the second article. The third article may be physically different from the first and/or the second article. The third article may be compositionally different from the first article but not physically different. The third article may be physically different from the first article but not compositionally different. The third article may be compositionally different from the second article but not physically different. The third article may be physically different from the second article but not compositionally different.

Compositional Differences

The plurality of articles may comprise a compositional difference between the first and second (and optionally third) articles. Put another way, the first and second articles (and optionally a third article) of the present disclosure may differ compositionally. Typically, “compositionally” and/or “compositional,” as used herein, relates to formulation differences, such as the presence (or absence) of a particular ingredient at a particular level at the time of manufacture. Typically, the terms are not intended to relate to changes that may occur after the manufacturing process, such as those that may result in exposure to humidity or heat upon storage or transport.

The active agents may be located in or at any suitable part of the articles or components thereof, for example part of the structure of the fibrous elements, applied onto a surface of the fibrous elements, applied onto a ply or between plies as a coating or a bead of active agent, part of a particle that is entangled in the fibrous elements, or a particle that is applied onto or between plies.

It is recognized that the first and second articles may have some active agents that are of the same identity and at the same level. However, at least one active agent may be different in terms of identity or level. The differences described below relate to the at least one active agent that is different.

The compositional difference may relate to a level of an active agent. For example, the first and second articles may each comprise the same active agent, but at different levels.

The levels of active agent may be measured in terms of weight percentage, by weight of each respective article. For example, a first article may include an active agent present at 2% by weight of the first article, and a second article may include the active agent present at 4% by weight of the second article. Such differences may result, e.g., when one article is loaded with relatively more of the active agent compared to the loading of another article.

The levels of active agent may be measured in terms of mass of the active agent per article. For example, a first article may include 1 gram of an active agent (e.g., 1 g/article), and a second article may include 3 grams of the active agent (e.g., 3 g/article). Such differences may result, e.g., when the same web is cut into articles of different sizes, so that the larger articles have more grams of the active agent than the smaller articles do.

The first article may comprise the active agent at a higher concentration level compared to the concentration level of the active agent in the second article, where concentration level is measured as weight percent by weight of the article. The first article may comprise the active level at a concentration level that is lower than the concentration level of the active agent in the second article, by weight of the article. The differences in levels may be at least 1%, or at least 5%, or at least 10%, or at least 20%, or at least 30%, or at least 50%, or at least 75%, or at least 100% different, based on the lower concentration. For example, a level of 6wt % active agent in a first article is 50% greater than a level of 4wt % active agent in a second article.

The active agent may be present in the first article but not in the second article (e.g., the second article is free of the active agent, or comprises 0wt %). The active agent may be present in the second article but not in the first article (e.g., the first article is free of the active agent, or comprises 0wt %).

The compositional difference may relate to at least one active agent. Suitable active agents include (and may be selected form the group consisting of): personal cleansing and/or conditioning agents such as hair care agents such as shampoo agents and/or hair colorant agents, hair conditioning agents, skin care agents, sunscreen agents, and skin conditioning agents; laundry care and/or conditioning agents such as fabric care agents, fabric conditioning agents, fabric softening agents, fabric anti-wrinkling agents, fabric care anti-static agents, fabric care stain removal agents, soil release agents, dispersing agents, suds suppressing agents, suds boosting agents, anti-foam agents, and fabric refreshing agents; liquid and/or powder dishwashing agents (for hand dishwashing and/or automatic dishwashing machine applications), hard surface care agents, and/or conditioning agents and/or polishing agents; other cleaning and/or conditioning agents such as antimicrobial agents, antibacterial agents, antifungal agents, fabric hueing agents, perfume, bleaching agents (such as oxygen bleaching agents, hydrogen peroxide, percarbonate bleaching agents, perborate bleaching agents, chlorine bleaching agents), bleach activating agents, chelating agents, builders, lotions, brightening agents, air care agents, carpet care agents, dye transfer-inhibiting agents, clay soil removing agents, anti-redeposition agents, polymeric soil release agents, polymeric dispersing agents, alkoxylated polyamine polymers, alkoxylated polycarboxylate polymers, amphilic graft copolymers, dissolution aids, buffering systems, water-softening agents, water-hardening agents, pH adjusting agents, enzymes, flocculating agents, effervescent agents, preservatives, cosmetic agents, make-up removal agents, lathering agents, deposition aid agents, coacervate-forming agents, clays, thickening agents, latexes, silicas, drying agents, odor control agents, antiperspirant agents, cooling agents, warming agents, absorbent gel agents, anti-inflammatory agents, dyes, pigments, acids, and bases; liquid treatment active agents; agricultural active agents; industrial active agents; ingestible active agents such as medicinal agents, teeth whitening agents, tooth care agents, mouthwash agents, periodontal gum care agents, edible agents, dietary agents, vitamins, minerals; water-treatment agents such as water clarifying and/or water disinfecting agents, and mixtures thereof.

The active agent may be selected from surfactant, perfume, one or more bleaching agents, enzymes, a polymeric dispersing agent, a soil release polymer, a fabric hueing agent, a fluorescent brightener, a dye transfer inhibiting agent, a hygiene or malodor agent, a conditioning or softening agent, or mixtures thereof.

The active agent in question may comprise a surfactant, which may provide cleaning benefits during intended use. Non-limiting examples of suitable surfactants include anionic surfactants, cationic surfactants, nonionic surfactants, zwitterionic surfactants, amphoteric surfactants, and mixtures thereof. The fibrous elements may contain an anionic surfactant, such as sulfated or sulfonated surfactants. The anionic surfactant may include alkyl alkoxylated sulfate such as alkyl ethoxylated sulfate (AES), alkyl benzene sulfonate such as linear alkyl benzene sulfonate (LAS), or mixtures thereof. The fibrous elements may contain LAS, which may improve the cleaning profile and/or dissolution profile of the fibrous elements. The surfactant may include surfactants derived from natural (non-synthetic) feedstock materials. 0

The active agent may comprise a perfume. The perfume may comprise a perfume ingredient selected from the group consisting of: aldehyde perfume ingredients, ketone perfume ingredients, esters, and mixtures thereof. Also included are various natural extracts and essences which can comprise complex mixtures of ingredients, such as orange oil, lemon oil, rose extract, lavender, musk, patchouli, balsamic essence, sandalwood oil, pine oil, cedar, and the like. In one example, a finished perfume typically is present at a level of from about 0.01% to about 2% by weight on a dry fibrous element basis and/or a dry particle basis and/or dry fibrous structure basis.

As used herein, the term “perfume” encompasses the perfume raw materials (PRMs) and perfume accords. The term “perfume raw material” as used herein refers to compounds having a molecular weight of at least about 100 g/mol and which are useful in imparting an odor, fragrance, essence or scent, either alone or with other perfume raw materials. As used herein, the terms “perfume ingredient” and “perfume raw material” are interchangeable. The term “accord” as used herein refers to a mixture of two or more PRMs.

The first article may comprise a first perfume, and the second article may comprise a second perfume that has a different compositional make-up than the first (e.g., different PRMs and/or PRMs at different levels).

The PRMs may characterized by their boiling points (B.P.) measured at the normal pressure (760 mm Hg), and their octanol/water partitioning coefficient (P). Based on these characteristics, the PRMS may be categorized as Quadrant I, Quadrant II, Quadrant III, or Quadrant IV perfumes, as described in more detail below.

Perfume raw materials having a B.P. lower than 250° C. and a ClogP lower than 3.0 are called Quadrant I perfumes. Perfume raw materials having a B.P. of about 250° C. or higher and a ClogP lower than 3.0 are called Quadrant II perfumes. Perfume raw materials having a B.P. less than 250° C. and a ClogP higher than about 3.0 are called Quadrant III perfumes. Perfume raw materials having a B.P. of about 250° C. or higher and a ClogP of about 3.0 or higher are called Quadrant IV perfumes or enduring perfumes.

Traditionally, perfume accords are formulated around “enduring” perfumes (Quadrant IV) due to their high deposition efficiency hence odor impact on fabrics, while “non-enduring” perfumes, especially Quadrant I perfume ingredients, are considered difficult to deposit onto fabrics and as such typically are used solely in very low amount to minimize waste and pollution. Quadrant I perfume ingredients are hydrophilic (e.g., a ClogP lower than 3.0) and have low boiling points (e.g., a B.P. lower than 250° C.); thus, they are easily lost to the wash or rinse medium or during heat drying. In compositions of the present disclosure, some non-enduring perfume ingredients, especially Quadrant I perfume ingredients, may be intentionally formulated, e.g., to improve the perfume odor in the headspace of the container to enable consumers to appreciate the perfume character of the contained water-soluble pouches. As described below, compositions of the present disclosure may include at least about 2%, or at least about 3%, or at least about 4%, by weight of the composition, of Quadrant I perfume ingredients.

Perfume according to the present disclosure may contain from about 15% to about 60%, preferably from about 20% to about 55%, more preferably from about 25% to about 50% by weight of the perfume accord of non-enduring perfume ingredients. Non-enduring perfume ingredients encompass Quadrant I, II and III perfume ingredients. Perfume according to the present disclosure may contain from about 2% to about 15%, preferably from about 3% to about 12%, more preferably from about 4% to about 10% by weight of the perfume accord of Quadrant I perfume ingredients. The perfume may include at least about 2%, or at least about 3%, or at least about 4%, by weight of the composition, of Quadrant I perfume ingredients.

Additionally or alternatively, the perfume may include from about 2.5% to about 25%, preferably from about 3% to about 20%, more preferably from about 5% to about 15% of Quadrant II perfume ingredients, from about 10% to about 50%, preferably from about 15% to about 45%, more preferably from about 20% to about 40% of Quadrant III perfume ingredients, and/or from about 40% to about 85%, preferably from about 45% to about 75%, more preferably from about 40% to about 65% of Quadrant IV perfume ingredients.

The perfume may be neat perfume, delivered by a perfume delivery system, or a combination thereof. The perfume delivery system may be an encapsulate. The encapsulate can be a pressure sensitive and/or friable encapsulate. Encapsulated perfumes comprise a core that comprises the perfume and a shell that comprises the encapsulate wall. The shell may comprise a material selected from the group consisting of polyethylenes; polyamides; polyvinylalcohols, optionally containing other co-monomers; polystyrenes; polyisoprenes; polycarbonates; polyesters; polyacrylates; aminoplasts, for example polyureas (including polyoxymethyleneurea and/or melamine formaldehyde), polyurethane, and/or polyureaurethane; polyolefins; polysaccharides, in one aspect said polysaccharide may comprise alginate and/or chitosan; gelatin; shellac; epoxy resins; vinyl polymers; water insoluble inorganics; silicone; and mixtures thereof. Preferred encapsulates comprise a shell which may comprise melamine formaldehyde and/or cross linked melamine formaldehyde. Other preferred capsules comprise a polyacrylate based shell.

The active agent may comprise one or more bleaching agents. Non-limiting examples of suitable bleaching agents include peroxyacids, perborate, percarbonate, chlorine bleaches, peroxygen bleach, percarboxylic acid bleach and salts thereof, oxygen bleaches, persuifate bleach, hypohalite bleaches, bleach precursors, bleach activators, bleach catalysts, hydrogen peroxide, bleach boosters, photobleaches, bleaching enzymes, free radical initiators, peroxygen bleaches, and mixtures thereof.

The active agent may comprise enzymes. Non-limiting examples of suitable enzymes include proteases, amylases, lipases, cellulases, carbohydrases including mannanases and endoglucanases, pectinases, pectate lyases, hemicellulases, peroxidases, xylanases, phospholipases, esterases, cutinases, keratanases, reductases, oxidases, phenoloxidases, lipoxygenases, ligrrinases, pullulanases, tannases, penosanases, malanases, glucanases, arabinosidases, hyaluraonidases, chrondroitinases, laccases, and mixtures thereof.

The active agent may comprise polymeric dispersing agents. Suitable polymeric dispersing agents may include carboxymethylcellulose, poly(vinyl-pyrrolidone), poly (ethylene glycol), poly(vinyl alcohol), poly(vinylpyridine-N-oxide), poly(vinylimidazole), polycarboxylates such as polyacrylates, maleic/acrylic acid copolymers and lauryl methacrylate/acrylic acid co-polymers.

Suitable polymeric dispersing agents include amphiphilic cleaning polymers such as the compound having the following general structure: bis((C₂H₅O)(C₂H₄O)n)(CH₃)—N⁺—CₓH₂ₓ—N⁺—(CH₃)-bis((C₂H₅O)(C₂H₄O)n), wherein n=from 20 to 30, and x=from 3 to 8, or sulphated or sulphonated variants thereof.

Suitable polymeric dispersing agents include amphiphilic alkoxylated grease cleaning polymers which have balanced hydrophilic and hydrophobic properties such that they remove grease particles from fabrics and surfaces. The amphiphilic alkoxylated grease cleaning polymers may comprise a core structure and a plurality of alkoxylate groups attached to that core structure. These may comprise alkoxylated polyalkylenimines, for example, having an inner polyethylene oxide block and an outer polypropylene oxide block. Such compounds may include, but are not limited to, ethoxylated polyethyleneimine, ethoxylated hexamethylene diamine, and sulfated versions thereof. Polypropoxylated derivatives may also be included. A wide variety of amines and polyalklyeneimines can be alkoxylated to various degrees. A useful example is 600 g/mol polyethyleneimine core ethoxylated to 20 EO groups per NH and is available from BASF. The detergent compositions described herein may comprise from about 0.1% to about 10%, and in some examples, from about 0.1% to about 8%, and in other examples, from about 0.1% to about 6%, by weight of the detergent composition, of alkoxylated polyamines.

Suitable polymeric dispersing agents include carboxylate polymer. Suitable carboxylate polymers, which may optionally be sulfonated, include a maleate/acrylate random copolymer or a poly(meth)acrylate homopolymer. In one aspect, the carboxylate polymer is a poly(meth)acrylate homopolymer having a molecular weight from 4,000 Da to 9,000 Da, or from 6,000 Da to 9,000 Da.

Suitable polymeric dispersing agents include alkoxylated polycarboxylates, which may also be used to provide grease removal. Chemically, these materials comprise poly(meth)acrylates having one ethoxy side-chain per every 7-8 (meth)acrylate units. The side-chains are of the formula —(CH₂CH₂O)m (CH₂)ₙCH₃ wherein m is 2-3 and n is 6-12. The side-chains are ester-linked to the polyacrylate “backbone” to provide a “comb” polymer type structure. The molecular weight can vary, but may be in the range of about 2000 to about 50,000. The detergent compositions described herein may comprise from about 0.1% to about 10%, and in some examples, from about 0.25% to about 5%, and in other examples, from about 0.3% to about 2%, by weight of the detergent composition, of alkoxylated polycarboxylates.

Suitable polymeric dispersing agents include amphiphilic graft co-polymers. A suitable amphiphilic graft co-polymer comprises (i) a polyethyelene glycol backbone; and (ii) and at least one pendant moiety selected from polyvinyl acetate, polyvinyl alcohol and mixtures thereof. A suitable amphilic graft co-polymer is Sokalan® HP22, supplied from BASF. Suitable polymers include random graft copolymers, for example, a polyvinyl acetate grafted polyethylene oxide copolymer having a polyethylene oxide backbone and multiple polyvinyl acetate side chains. The molecular weight of the polyethylene oxide backbone is typically about 6000 and the weight ratio of the polyethylene oxide to polyvinyl acetate is about 40 to 60 and no more than 1 grafting point per 50 ethylene oxide units.

The active agent may include soil release polymers. Suitable soil release polymers may include monomers of ethylene terephthalate or propylene terephthalate with polyethylene oxide or polypropylene oxide terephthalate. Suitable soil release polymers may include polyester soil release polymers such as Repel-o-tex polymers, including Repel-o-tex SF, SF-2 and SRP6 supplied by Rhodia. Other suitable soil release polymers include Texcare polymers, including Texcare SRA100, SRA300, SRN100, SRN170, SRN240, SRN300 and SRN325 supplied by Clariant. Other suitable soil release polymers are Marloquest polymers, such as Marloquest SL supplied by Sasol.

The active agent may comprise a fabric hueing agent. A fabric hueing agent (sometimes referred to as shading, bluing or whitening agents) typically provides a blue or violet shade to fabric. Hueing agents can be used either alone or in combination to create a specific shade of hueing and/or to shade different fabric types. This may be provided for example by mixing a red and green-blue dye to yield a blue or violet shade. Hueing agents may be selected from any known chemical class of dye, including but not limited to acridine, anthraquinone (including polycyclic quinones), azine, azo (e.g., monoazo, disazo, trisazo, tetrakisazo, polyazo), including premetallized azo, benzodifurane and benzodifuranone, carotenoid, coumarin, cyanine, diazahemicyanine, diphenylmethane, formazan, hemicyanine, indigoids, methane, naphthalimides, naphthoquinone, nitro and nitroso, oxazine, phthalocyanine, pyrazoles, stilbene, styryl, triarylmethane, triphenylmethane, xanthenes and mixtures thereof.

Suitable fabric hueing agents include dyes, dye-clay conjugates, and organic and inorganic pigments. Suitable dyes also include small molecule dyes and polymeric dyes. Suitable small molecule dyes include small molecule dyes selected from the group consisting of dyes falling into the Colour Index (C.I.) classifications of Direct, Basic, Reactive or hydrolysed Reactive, Solvent or Disperse dyes for example that are classified as Blue, Violet, Red, Green or Black, and provide the desired shade either alone or in combination. Suitable polymeric dyes include polymeric dyes selected from the group consisting of polymers containing covalently bound (sometimes referred to as conjugated) chromogens, (dye-polymer conjugates), for example polymers with chromogens co-polymerized into the backbone of the polymer and mixtures thereof. Suitable polymeric dyes also include polymeric dyes selected from the group consisting of fabric-substantive colorants sold under the name of Liquitint® (Milliken, Spartanburg, S.C., USA), dye-polymer conjugates formed from at least one reactive dye and a polymer selected from the group consisting of polymers comprising a moiety selected from the group consisting of a hydroxyl moiety, a primary amine moiety, a secondary amine moiety, a thiol moiety and mixtures thereof. Suitable polymeric dyes also include polymeric dyes selected from the group consisting of Liquitint® Violet CT, carboxymethyl cellulose (CMC) covalently bound to a reactive blue, reactive violet or reactive red dye such as CMC conjugated with C.I. Reactive Blue 19, sold by Megazyme, Wicklow, Ireland under the product name AZO-CM-CELLULOSE, product code S-ACMC, alkoxylated triphenyl-methane polymeric colourants, alkoxylated thiophene polymeric colourants, and mixtures thereof.

The aforementioned fabric hueing agents can be used in combination (any mixture of fabric hueing agents can be used).

The active agent may comprise a fluorescent brightener. Commercial fluorescent brighteners suitable for the present disclosure can be classified into subgroups, including but not limited to: derivatives of stilbene, pyrazoline, coumarin, benzoxazoles, carboxylic acid, methinecyanines, dibenzothiophene-5,5-dioxide, azoles, 5- and 6-membered-ring heterocycles, and other miscellaneous agents.

The active agent may comprise dye transfer inhibiting agents. Dye transfer inhibiting agents are effective for inhibiting the transfer of dyes from one fabric to another during the cleaning process. Generally, such dye transfer inhibiting agents may include polyvinyl pyrrolidone polymers, polyamine N-oxide polymers, copolymers of N-vinylpyrrolidone and N-vinylimidazole, manganese phthalocyanine, peroxidases, and mixtures thereof. If used, these agents may be used at a concentration of about 0.0001% to about 10%, by weight of the composition, in some examples, from about 0.01% to about 5%, by weight of the composition, and in other examples, from about 0.05% to about 2% by weight of the composition.

The active agent may comprise a hygiene and/or malodor agent. Suitable hygiene and malodor active agents may include zinc ricinoleate, thymol, quaternary ammonium salts such as Bardac®, polyethylenimines (such as Lupasol® from BASF) and zinc complexes thereof, silver and silver compounds, especially those designed to slowly release Ag⁺ or nano-silver dispersions.

The active agent may include conditioning agents and/or softening agents. Suitable conditioning/softening agents may include quaternary ammonium compound, silicone, fatty acids or esters, sugars, fatty alcohols, alkoxylated fatty alcohols, polyglycerol esters, oily sugar derivatives, wax emulsions, fatty acid glycerides, or mixtures thereof. The quaternary compound may be selected from the group consisting of linear quaternary ammonium compounds, branched quaternary ammonium compounds, cyclic quaternary ammonium compounds, and mixtures thereof. The silicone may be selected from the group consisting of polydimethylsiloxane (PDMS), aminosilicone, silicone polyether, cationic silicones, silicone polyurethane, silicone polyureas, and mixtures thereof.

Physical Differences

The plurality of articles may comprise a physical difference between the first and second (and optionally third) articles. Put another way, the first and second articles (and optionally a third article) of the present disclosure may differ physically.

By “physical difference,” it is meant a difference in a feature that can be perceived by sight and/or touch. Physical differences may also include structural differences between the first and second (and third) articles. That being said, it may be preferred that the physical difference are readily apparent upon sight and/or touch so as to send the desired cue to the user. The physical difference may be a visual difference and/or a tactile difference (which, as used herein, is intended to include shape differences).

The physical difference may relate to a feature selected from the group consisting of size, shape, color, graphical indicia, texture, basis weight, and combinations thereof. These features are discussed in more detail below.

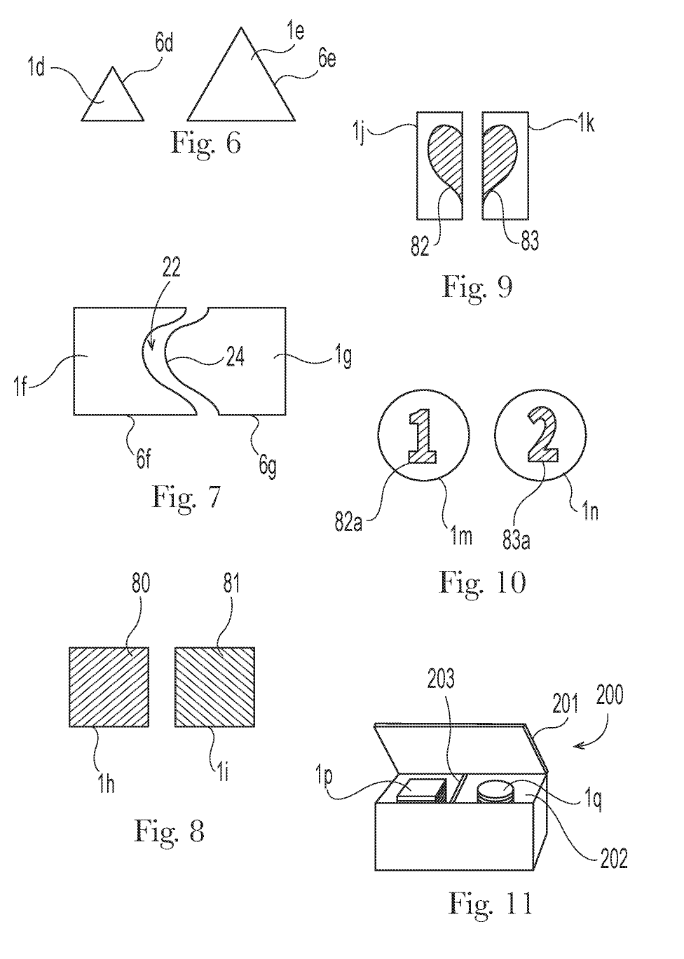

The physical difference may relate to size, as shown in FIG. 6. The first article 1d may have a first size, and the second article 1e may have a second size. The first article 1d may be relatively smaller larger than the second article 1e, or relatively larger. Being “larger” may relate to any suitable measurement, dimension, or combinations of dimensions. The measurements may be selected from height, width, thickness, surface area, area of the shape defined by the perimeter, mass, or volume. The first article may have a greater length than the second article. The first article may have a greater width than the second article. The first article may have a greater thickness than the second article. The first article may have a greater surface area than the second article. The first article may have a perimeter that defines a greater area than the area defined by the perimeter of the second article. The first article may have a greater mass than the second article. The first article may have a greater volume than the second article. The second article may be greater in any or all of the above-listed measurements compared to the first article. It may be that the first article is greater in one measurement, but the second article is greater in a different measurement. The first and second articles may differ by at least 5%, or by at least 10%, or by at least 20%, or by at least 30%, or by at least 40%, or by at least 50% of the measurement in question; the percentage difference is determined using the less measurement as reference (e.g., a width of 4.5 cm is 50% greater than a width of 3 cm). Having articles of different sizes may relate, for example, to the recommended dose size of the actives contained therein. Further, larger sizes may indicate to the user that the articles are suitable, for example, for large or heavily soiled fabrics.

The physical difference may relate to shape, as shown in FIG. 7. The difference in shape may be a two-dimensional difference or a three-dimensional difference. For example, the perimeter of the first article if may define a first shape, and the perimeter of the second article 1g may define a second shape, where the first and second shape are not identical. The first and/or second shape may be of any suitable shape, including standard geometric shapes such as circles, ovals, squares, rectangles, rhomboids, pentagons, hexagons, octagons, and the like.

The shapes of the first and second articles may be complementary. For example, the shape, in two or three dimensions, of the first article may be capable of receiving the shape of the second, like a jigsaw puzzle or lock-and-key. The shape, in two or three dimensions, of the second article may be capable of receiving the shape of the first. The shape of the first article 1f may include a concave portion 22 capable of receiving a convex portion 24 of a second article 1g, or vice versa.

The perimeters of the first article may define a shape that is tessellateable with the shape defined by the perimeter of the second article. As used herein, the term “tessellateable” (and derivatives thereof) is used in the sense that the shape or shapes in question can cover or tile a surface, for example a planar surface. The shapes can fit together like a jigsaw to form a continuous tiled planar surface with no substantial gaps or overlays, except for optional gaps at the edges of the (planar) surface. The shapes may be shaped to nest and/or interlock with one another, or they may be capable of simply being adjacent to each other with no significant gaps or overlay. Shapes that may be tessellated include square, rectanglar, kite-like, and hexagonal shapes. Other shapes may include relatively concave portions that may be shaped to receive relatively convex portions of another (same or different) shape. The articles 1f, 1g of FIG. 7 are tessellatable. Shapes of different sizes and/or perimeter shapes may be combined to form a tessellated pattern. Articles, for example articles having rounded corners, may still be considered as having tessellated shapes if, when placed on a surface in the most efficiently tessellated arrangement possible, no more than 10%, or no more than 5%, or no more than 3% of the surface area of the underlying surface is visible between the articles. Tessellateable shapes may be useful in communicating that two articles are intended to be used together, especially when the shape of one article “fits” into the shape of another, as shown in FIG. 7.

Additionally, the shape defined by the perimeter of the first article may be tessellateable with itself, as such shapes can reduce waste in the manufacturing process.

The shape of an article may relate to the active agent contained therein and/or the intended target surface for treatment. For example, the articles shape may indicate the target surface, and the article may comprise active agents suitable for that surface. I.e., the article may be in the shape of denim jeans, and the article may comprise dye transfer inhibitors; the article may be in the shape of a toilet bowl and may contain a bleaching agent. Such shapes may effectively communicate to the user on which surface to use (or to not use) the article.

The physical difference may relate to color. A first article 1h may comprise a first color 80, and a second article 1i may comprise a second color 81 that is different than the first color 80. For example, different colors or color schemes may be used to show that the articles are compositionally different. For example, a dark blue color may indicate that the article is suitable for laundering dark fabrics; a white color may indicate that the article is suitable for white loads. Furthermore, the color may correspond to one or more active agents comprised in or on the article. A darkly colored article, suitable for dark laundry loads, may contain a dye transfer inhibitor agent and/or a dye fixative. A brightly colored article, suitable for colored loads, may contain a color rejuvenation polymer, such as a cationic polymer. A lightly colored or white article, suitable for white loads, may contain bleach. Such color-coding may help the user select the correct article for the job at hand.

Colors may also help to communicate which articles should (or shouldn't) be used in combination. For example, a first article may comprise a color in a dark hue, and a second article may comprise the same general color in a lighter hue (e.g., dark blue and light blue). The first article may show a colored pattern or spectrum across a surface that is picked up by the second article. For example, red, orange, yellow and green may be located on first article, and green, blue, indigo, and violet may be located on a second article; together, they provide the colors of the rainbow (ROYGBIV). Although the articles may have a difference in color, they still may have some colors in common. For example, in the previous example, both articles comprised green, e.g., at adjacent edges, thereby providing a further visual cue that they are to be associated with each other.

The physical difference may relate to graphical indicia. The graphical indicia may include any text, symbol or shape that can be printed onto the surface of the articles. The graphical indicia may indicates the origin of said unit dose product; the manufacturer of the unit dose product; an advertising, sponsorship or affiliation image; a trade mark or brand name; a safety indication; a product use or function indication; a number; a sporting image; a geographical indication; an industry standard; preferred orientation indication; an image linked to a perfume or fragrance; a charity or charitable indication; an indication of seasonal, national, regional or religious celebration, in particular spring, summer, autumn, winter, Christmas, New Years; or any combination thereof. Further examples include random patterns of any type including lines, circles, squares, stars, moons, flowers, animals, snowflakes, leaves, feathers, sea shells and Easter eggs, amongst other possible designs.

The graphical indicia of an article may relate to the one or more active ingredients comprised therein or thereon. For example, the graphical indicia may relate to the perfume composition, thereby providing a cue to the user as to what scent to expect. A graphical indicia of a pine tree may indicate a pine or woodsy scent; a bundle of lemons may indicate a citrus smell. As another example, the graphical indicia may relate to the target surface for which one or more of the active agents comprised therein is suitable; for example, a bleach-containing article may comprise a graphical indicia depicting a white shirt or a toilet bowl. Such indications may help the user select the right article for the job at hand.

As shown in FIG. 9, the first article 1j may comprise a first graphical indicia 82, and the second article 1k may comprise a second graphical indicia 83. The first and second graphical indicia 82, 83 may be complementary in some fashion. Complementary graphics may be particularly useful when the first and second articles are intended to be used together, either simultaneously or in series, as they provide a cue to the user that they are to be used in combination.

For example, the first and second indicia 81, 82 may each be a partial indicia that, when placed side-by-side, form a complete indicia (e.g., two halves of a heart make a complete heart—see FIG. 9; similarly “TI” and “DE” spell “TIDE”). The first and second indicia 82, 83 may be associated with, or suggestive of, each other (e.g., a flower and a bee).

Graphical indicia may form a predetermined sequence; for example, as shown in FIG. 10, a first article 1m may comprise the number “1” or the letter “A”, and a second article 1n may comprise the number “2” or the letter “B”, respectively. Indicia of a predetermined sequence 82a, 83a may be indicative of the order in which the articles are to be used; each article may include active agents that are to be used in that same sequence, for example detergent and softener.

One of the first and second articles may comprise graphical indicia, whereas the other of the first and second articles may not comprise graphical indicia.

The physical difference may relate to texture. The first article may have a surface that is relatively rougher than a corresponding surface of a second article; increased roughness may indicate to the consumer that the article is suitable for heavily soiled fabrics, such as those resulting from manual labor. The first article may have a surface that is relatively smoother than a corresponding surface of a second article; smoother articles may indicate to the consumer that the article is suitable for lighter fabrics, such as delicates. Additionally or alternatively, a smoother texture may provide an indication of the functionality of the article; for example, a smoother article may be desired in combination with a conditioning agent, such as a conditioning silicone, quaternary softening compound, or a cationic polymer. The texture may more directly relate to the types of surfaces for which the article is suitable. For example, the texture may feature raised sections depicting illustrations of the target surface, for example pictures of t-shirts or toilets. The texture of the article may approximate the texture of the target surface, for example silky fabrics. Different textures may be provided by embossing the webs or articles, or by forming the parent web on a belt that has the desired pattern. Such textural cues may be particularly useful to users who are visually impaired.

The physical difference may relate to basis weight. Articles having a greater basis weight may be viewed by the user has having, e.g., more cleaning power and/or being better suited to bigger jobs. Relatedly, the physical difference may relate to density. Articles having relatively greater densities may connote, e.g., more cleaning power to the user.

The physical difference may be a result, directly or indirectly, of the compositional difference. For example, a first article that comprises a hueing dye may appear blue or purple, where a second article that does not comprise a hueing dye may not have the same color appearance. An article that comprises a silicone, a quat, or cationic polymer may feel smoother to the touch compared to an article that does not comprise a similar ingredient.

Container

The articles of the present disclosure may be packaged in one or more containers 200. Suitable containers 200 may include tubs, boxes, and/or flexible bags. The container may optionally contain a removeable tray and/or an interior bag or wrapping. The container 200 may be resealable, for example with a recloseable lid 201.

A container 200 may contain a plurality of the articles 1p, 1q in an interior volume 202. A first container may contain a plurality of first articles. A second container may contain a plurality of second articles. A single container 200 may comprise a one or more first articles 1p and one or more second articles 1q. Without wishing to be bound by theory, it is believed that the physical differences of the first and second articles will aid the user in selecting the desired article that has the desired active agent and/or benefit profile, particularly when selecting an article from a container that includes both first and second articles.

The container may be substantially impervious to ingress by water and/or water vapor when closed. Such containers are desirable because water may negatively affect the integrity of the water-soluble unit dose articles 1, leading, e.g., to a poor consumer experience.

The first and second (and optionally third) articles 1p, 1q may be separated by one or more dividers 203, or they may be present in the same/shared space or compartment of the container 200.

### Process of Treating a Surface

The present disclosure relates to process of treating a surface. Suitable surfaces to be treated may include hard surfaces (i.e., kitchen countertops, bath tubs, toilets, toilet bowls, sinks, floors, walls, teeth, cars, windows, mirrors, dishes) and/or soft surfaces (i.e., fabric, hair, skin, carpet, crops, plants).

In particular, the articles of the present disclosure may useful in household care applications, such as laundry, dish, and/or surface care applications. Thus, the surface to be treated may be any suitable household care surface, such as fabric, dishware, glassware, silverware, or hard surfaces such as sinks, tile, or porcelain. The surface may be fabric and/or dishware, preferably fabric.

The articles of the present disclosure may be useful in personal care applications, such as hair care, oral care, or skin care. Thus, the surface to be treated may include hair, skin, and/or teeth.

The process may comprise a plurality of water-soluble unit dose articles, including a first water-soluble unit dose article and a second water-soluble unit dose article. The first and second articles may each comprise at least a first ply, the first ply comprising a plurality of fibrous elements, each fibrous element comprises at least one filament-forming material and, optionally, a surfactant. The structure and components of the unit dose articles of the present disclosure are described in more detail above.

The process may include the step of contacting the target surface with water in which a first water-soluble unit dose article has been dissolved; a first aqueous liquor may be formed. The process may include the step of contacting the target surface with water in which a second water-soluble unit dose article has been dissolved, a second aqueous liquor may be formed. Dissolving the articles may allow the active agents comprised therein to be released and act on the target surface as intended.

The articles may be dissolved in a suitable receptacle, such as an automatic washing machine for laundry or dishes. Other suitable receptacles include a sink or a bucket. Treatment processes may use any suitable implement, such as a brush, mop, or cloth.

The dissolution step may take place in any suitable temperature of water. Warmer temperatures may be preferred, e.g., to facilitate improved dissolution and/or cleaning. Cooler temperatures may be preferred, e.g., for energy savings. The temperature of the water may be from about 1° C., or from about 5° C., or from about 10° C., or from about 15° C., to about 90° C., or to about 60° C., or to about 40° C., or to about 30° C., or to about 25° C. The temperature of the water in which the first article is dissolved may be different from the temperature of the water in which the second article is dissolved.

The first and second articles may be dissolved in the same water or in different water. The first and second articles may be dissolved at substantially the same time (e.g., in the same wash cycle of an automatic washing machine), or in series (e.g., one in the wash cycle of an automatic washing machine, another in the rinse cycle). The contacting steps may occur at substantially the same time or at different times, e.g., sequentially in the same process or as part of different processes separated by time.

As described in more detail above, the first and second articles may be characterized by a compositional difference. The compositional difference may relate to at least one active agent listed above. The at least one active agent may comprise perfume.

As described in more detail above, the first and second articles may be characterized by a physical difference. The physical difference may relate to a feature selected from the group consisting of size, shape, color, graphical indicia, texture, basis weight, and combinations thereof. The physical difference may relate to color, graphical indicia, or both.

### Process of Making Water-Soluble Unit Dose Articles

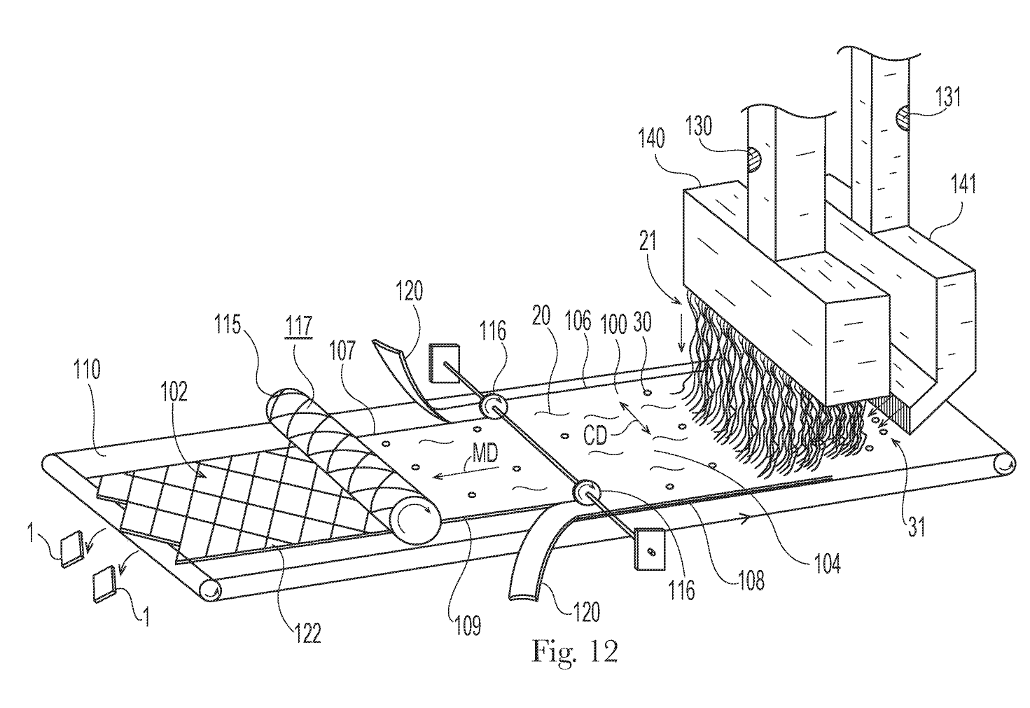

The present disclosure relates to processes of making water-soluble unit dose articles. Broadly, the process may include the steps of providing a water-soluble web 100 and cutting the web 100, for example in a tessellated pattern 102, to form a plurality of water-soluble unit dose articles 1, as shown in FIG. 12.

The process may include providing a water-soluble web 100. The web 100 may comprise a plurality of fibrous elements 20. Each fibrous element 20 may include at least one filament forming material and optionally a surfactant. Fibrous elements 20 and the components thereof are described in more detail above.

The web may include at least a first ply. The web 100 may include a second ply, or even a third ply. The multiple plies may be formed, at least in part, from a single parent material that is folded upon itself to form the web 100. The multiple plies may be formed, at least in part, from a single parent material that is cut and stacked upon itself to form the web 100. The material may be flipped or rotated by 180° in addition to being folded and/or stacked. As discussed above, the plies may include more than one layer.

As shown in FIG. 12, the web 100 may be located on an endless surface 110, such as a belt. The web 100 may be moving in a machine direction MD. The web may have a width in the cross-machine direction CD, which is orthogonal to the machine direction MD in the plane of the endless surface 110.

The web 100 may include a middle portion 104 near the centerline of the web 100 in the machine direction MD. The web 100 may include side edges 106, 108 away from the centerline in the cross-machine direction CD.

A cutting apparatus 115 may cut the web 100, for example in a tessellated pattern 102. The cutting apparatus 115 may be die cutter, for example a rotary die cutter. The cutting apparatus 115 may include a tessellated surface 117 that corresponds to the tessellated pattern 102.

Cutting the web 100 in a tessellated pattern 102 can form unit dose articles 1. The resulting unit dose articles 1 may be of the same size and/or shape. The resulting unit dose articles 1 may have different sizes and/or shapes, as described in more detail above.

After cutting the web 100, at least some of the unit dose articles 1 may be separated prior to packaging. Alternatively, some or all of the unit dose articles 1 may remain connected, at least partially. For example, the web 100 may be scored or perforated between the unit dose articles 1. Prior to use, the articles 1 could be torn away or otherwise separated from the other articles by a consumer and used as intended. In the present disclosure, it is contemplated that “cutting” the web 100 may including scoring and/or perforating the web 100 in a tessellated pattern.

As shown in FIG. 12, a portion 120 of the web that does not form unit dose articles may be removed. A portion 120 of the web 100 may be removed prior to cutting the web 100 in the tessellated pattern 102. The web 100 may be cut by a cutting tool, such as a rotating blade 116. The removed portion 120 may be near a side edge 106, 108 of the web 100, resulting in a trimmed edge 107, 109 of the remaining web. Trimming the web 100 in such fashion may be useful to provide a more uniform web 100 prior to cutting the web 100 into unit dose articles 1. For example, the web 100 may be relatively thinner near the side edges 106, 108 compared to the middle portion 104, resulting in webs 100 and/or articles 1 having nonuniform caliper, which may require additional handling or result in product variability. As a result of the removal or trimming step, the width of the web 100 measured from trimmed edge 107 to trimmed edge 109, measured in the cross-machine direction CD, will be less than the width of the web 100 as measured from the (untrimmed) side edge 106 to side edge 108.

A portion 122 may be removed after the web 100 has been cut in a tessellated fashion. Such portions 122 may be located near a side edge 106, 108 and/or a finished edge 107, 109. It may be desirable to remove portions 122 after cutting when the portions 122 are not suitable for sale as a finished product, such as a unit dose article 1. Such portions 122 may be excess trim that is discarded or recycled. It is believed that tessellation according to the present disclosure is useful in minimizing such portions 122. In particular, it is expected that little to no such trim will be removed from the middle portion 104 of the web 100 after cutting.

The web 100 may be pre-made (i.e., at a different time and/or location). The web 100 may then be fed onto an endless surface 110.

The web may be made as part of a continuous article manufacturing process. Thus, the process of the present disclosure may include a web-forming step. Forming the web in a continuous process may be advantageous because there is no pre-made web to store and/or transport. For example, fibrous elements 20 may be deposited in a fibrous element stream 21 onto an endless surface 110 that is moving in a machine direction MD to form the web 100. The process may comprise the step of providing a solution of a filament-forming composition 130. The filament-forming composition 130 may be passed through one or more die block assemblies 140, which may comprise a plurality of spinnerets, to form a plurality of fibrous elements 20.

Optionally, multiple filament-forming compositions may be supplied to a single die block assembly 40 or portions thereof or multiple filament-forming compositions may be supplied to multiple die block assemblies. Multiple die block assemblies may be useful when more than one layer in a web 100 or ply is desired.

The fibrous elements of the present invention may be made from a filament-forming composition. The filament-forming composition can be a polar-solvent-based composition, preferably a water-based composition. The filament-forming composition may comprise from about 10% to about 80% by weight of a polar solvent, such as water. The filament-forming composition may be an aqueous composition comprising one or more filament-forming materials and one or more active agents.

The filament-forming composition may comprise one or more release agents and/or lubricants, such as fatty acids, fatty acid salts, fatty alcohols, fatty esters, sulfonated fatty acid esters, fatty amine acetates and fatty amides, silicones, aminosilicones, fluoropolymers and mixtures thereof. The filament-forming composition may comprise one or more antiblocking and/or detackifying agents, such as starches, modified starches, crosslinked polyvinylpyrrolidone, crosslinked cellulose, microcrystalline cellulose, silica, metallic oxides, calcium carbonate, talc and mica.

A suitable spinning operation and/or spinning process may be used to form a fibrous material from the filament-forming composition, including spunbonding, melt blowing, electro-spinning, rotary spinning, continuous filament producing and/or tow fiber producing operations/processes. For example, the filament-forming composition may spun into a plurality of fibrous elements by meltblowing. The filament-forming composition may be pumped from a tank to a meltblown spinnerette. Upon exiting one or more of the filament-forming holes in the spinnerette, the filament-forming composition may be attenuated with air to create one or more fibrous elements and/or particles. The fibrous elements may then be dried to remove any remaining solvent used for spinning, such as the water.

The spinnerets may comprise a plurality of fibrous element-forming holes that include a melt capillary encircled by a concentric attenuation fluid hole through which a fluid, such as air at a temperature from about 10 C to about 100 C, can pass to facilitate attenuation of the filament-forming composition into a fibrous element as it exits the fibrous element-forming hole. The filament-forming composition can be provided to the fibrous-element forming hole at a rate of about 0.1 to about 2 g/min per hole, which can be set based on the composition of the filament-forming composition.

The process may include adding particles 30 to the web 100, for example, by combining (e.g., by blowing) particles 30 in a particle stream 31 with the fibrous elements 20 as they are deposited as a fibrous elements stream 21 on the endless surface 110 moving in the machine direction MD. Additionally or alternatively, the process may include adding particles 30 to the web 100 after the fibrous elements 20 have been placed upon the endless surface 110. Prior to combining the particles 30 with the fibrous elements 20 and/or the web 100, the particles 30 may be in the form of a particle slurry 131. The particle slurry 131 may be passed through one or more die block assemblies 141.

The fibrous elements and/or particles of the present invention may be collected on an endless surface, such as a belt, e.g., a patterned belt or flat belt, to form a ply 10 or web 100.

Although not shown in FIG. 9, the web 100 may be modified before or after the step of cutting the web 100 into the unit dose articles 1. For example, active ingredients may be added to the web by spraying, brushing, coating, and/or applying a bead of a composition that includes the active ingredient(s). The active ingredients may be added in a continuous manner, which may be advantageous because adding the ingredients intermittently can lead to registration problems when the web is cut, and inconsistent articles 1 as a result. Cutting the web 100 in a tessellated pattern 102 can help to reduce the waste of these active ingredients, in addition to reducing waste of the web material itself (e.g., the fibrous elements 20).

When the web 100 includes at least a first and second ply 10, 12, the process may further comprise the step of joining at least the first ply 10 and the second ply. The steps of cutting the web 100 and joining the first and second plies 10, 12 may occur in a single step or action. For example, the cutting apparatus 110, such as a die cutter, may be configured to join or seal the plies 10, 12 together at the same time it cuts the web 100. The plies may optionally be joined by using a bonding roll, or via thermal bonding, calendar bonded, point bonded, ultrasonically bonded, infrared bonded, through air bonded, needle punched, hydroentangled, melt bonded, adhesive bonded, or other known technical approach for bonding plies of material.

When the web 100 comprises at least two plies, the cutting of the web 100 and the joining of at least the first and second plies may occur in the same step. The plies can be bonded to one another and die cut in a single step using a single rotary bonding and die cutting apparatus.

The web 100 and/or the unit dose articles 1 may be printed upon. The printing can be laser jet, ink jet, gravure, pad, rotogravure, flexographic, offset, screen, lithographic, or any other printing approach suitable for printing webs of material, particularly process that are best suited for nonwoven materials.

The processes of the present disclosure may comprise providing and cutting a first web to form first articles, and providing and cutting a second web to form second articles. The first and second webs (and thus the first and second articles) may be characterized by a compositional difference, such as a difference in the type and/or amount of one or more active agents. The first web and/or the second web may be different or modified in such a manner so that the resulting articles cut from each are characterized by a physical difference. The differences or modifications may include differences in web-forming, printing, and/or cutting. Compositional and physical differences are described in more detail above.

The process may comprise placing the water-soluble unit dose articles 1 in a container. The container may be an open package. After the articles 1 are placed into the open package, the package may be sealed to form a closed package. The closed package may be suitable for vending to consumers. The package may be a box, optionally with a removable tray, or a flexible bag. The package may be substantially impervious to ingress by water and/or water vapor. Such packages are desirable because water may negatively affect the integrity of the water-soluble unit dose articles 1, leading, e.g., to a poor consumer experience.

First articles and second articles (and optionally third articles) according to the present disclosure may be co-located or packaged in the same container. The first and second (and optionally third) articles may be separated by one or more dividers, or they may be present in the same/shared space.

### Combinations

Specifically contemplated combinations of the disclosure are herein described in the following lettered paragraphs. These combinations are intended to be illustrative in nature and are not intended to be limiting.

A. A plurality of water-soluble unit dose articles, the plurality comprising at least a first article and a second article, each article comprising at least a first ply, the first ply comprising a plurality of fibrous elements, each fibrous element comprises at least one filament-forming material and, optionally, a surfactant, wherein the plurality comprises a compositional difference between the first and second articles, and wherein the plurality comprises a physical difference between the first and second articles.

B. A plurality of water-soluble unit dose articles according to paragraph A, wherein the compositional difference relates to at least one active agent selected from surfactant, perfume, one or more bleaching agents, enzymes, a polymeric dispersing agent, a soil release polymer, a fabric hieing agent, a fluorescent brightener, a dye transfer inhibiting agent, a hygiene or malodor agent, a conditioning or softening agent, or mixtures thereof.

C. A plurality of water-soluble unit dose articles according to any of paragraphs A-B, wherein the compositional difference relates to a level of the active agent.

D. A plurality of water-soluble unit dose articles according to any of paragraphs A-C, wherein the first article comprises the active agent at a higher concentration level compared to the concentration level of the active agent in the second article.

E. A plurality of water-soluble unit dose articles according to any of paragraphs A-D, wherein the active agent is present in the first article but not the second article, or is present in the second article but not the first article.

F. A plurality of water-soluble unit dose articles according to any of paragraphs A-E, wherein the physical difference relates to a feature selected from the group consisting of size, shape, color, graphical indicia, texture, basis weight, and combinations thereof.

G. A plurality of water-soluble unit dose articles according to any of paragraphs A-F, wherein the physical difference relates to size, wherein the first article is relatively larger than the second article.

H. A plurality of water-soluble unit dose articles according to any of paragraphs A-G, wherein the physical difference relates to shape.

I. A plurality of water-soluble unit dose articles according to any of paragraphs A-H, wherein the first and second articles each have a shape, where the shape of the first article is physically complementary to the shape of the second article.

J. A plurality of water-soluble unit dose articles according to any of paragraphs A-I, wherein the physical difference relates to color.

K. A plurality of water-soluble unit dose articles according to any of paragraphs A-J, wherein the physical difference relates to graphical indicia.

L. A plurality of water-soluble unit dose articles according to any of paragraphs A-K, wherein the first and second articles are co-located in a container.

M. A plurality of water-soluble unit dose articles according to any of paragraphs A-L, wherein the plurality further comprises a third article, wherein the plurality comprises a compositional difference between the first, second, and third articles, and wherein the plurality comprises a physical difference between the first, second, and third articles.

N. A process for treating a surface, the process comprising the steps of: contacting the surface with water in which a first water-soluble unit dose article has been dissolved, contacting the surface with water in which a second water-soluble unit dose article has been dissolved, wherein the first and second articles each comprise at least a first ply, the first ply comprising a plurality of fibrous elements, each fibrous element comprises at least one filament-forming material and, optionally, a surfactant, wherein the first and second articles are characterized by a compositional difference, and wherein the first and second articles are characterized by a physical difference.

O. A process according to paragraph N, wherein the compositional difference relates to at least one active agent selected from surfactant, perfume, one or more bleaching agents, enzymes, a polymeric dispersing agent, a soil release polymer, a fabric hueing agent, a fluorescent brightener, a dye transfer inhibiting agent, a hygiene or malodor agent, a conditioning or softening agent, or mixtures thereof.

P. A process according to any of paragraphs N-O, wherein the at least one active agent comprises perfume.

Q. A process according to any of paragraphs N-P, wherein the physical difference relates to a feature selected from the group consisting of size, shape, color, graphical indicia, texture, basis weight, and combinations thereof.

R. A process according to any of paragraphs N-Q, wherein the physical difference relates to color, graphical indicia, or both.

S. A process according to any of paragraphs N-R, wherein the first and second articles are dissolved in the same water.

T. A process according to any of paragraphs N-S, wherein the surface is a fabric.

U. A process or article according to any of paragraphs A-T, wherein the article(s) have a length (i.e., the longest dimension) of no greater than 15 cm, or no greater than 12 cm, or no greater than 10 cm, optionally the length being no less than 3 cm, no less than 4 cm, or no less than 5 cm, or no less than 6 cm, and having a ratio of the perimeter to the area of the shape defined by the perimeter (“perimeter:area ratio”) in the range of from 3:10 cm⁻¹, or from 4:10 cm⁻¹, to no greater than 12:10 cm⁻¹ (e.g., 1.2 cm⁻¹), or no greater than 10:10 cm⁻¹, or no greater than 8:10 cm⁻¹, or no greater than 6:10 cm⁻¹.

### Test Methods

### Thickness Test Method

The thickness of a fibrous structure and/or article height is measured using a ProGage Thickness Tester (Thwing-Albert Instrument Company, West Berlin, N.J.) with a circular pressure foot diameter of 2.00 inches (area of 3.14 in²) at a pressure of 15.5 g/cm². Five (5) samples are prepared by cutting samples of a fibrous structure such that each cut sample is larger in size than the pressure foot surface, avoiding creases, folds, and obvious defects. If an article has a length or width less than the diameter of the pressure foot a smaller diameter pressure foot may be used, while making the appropriate adjustments so that a pressure of 15.5 g/cm² is still applied. An individual sample is placed on the anvil with the sample centered underneath the pressure foot, or centered on the location of the maximum height of an article. The foot is lowered at 0.03 in/sec to an applied pressure of 15.5 g/cm². The reading is taken after 3 sec dwell time, and the foot is raised. The measure is repeated in like fashion for the remaining 4 samples. The thickness or article height is calculated as the average thickness of the five samples and is reported to the nearest 0.01 mm.

### Diameter Test Method

The diameter of a discrete fibrous element or a fibrous element within a fibrous structure is determined by using a Scanning Electron Microscope (SEM) or an Optical Microscope and an image analysis software. A magnification of 200 to 10,000 times is chosen such that the fibrous elements are suitably enlarged for measurement. When using the SEM, the samples are sputtered with gold or a palladium compound to avoid electric charging and vibrations of the fibrous element in the electron beam. A manual procedure for determining the fibrous element diameters is used from the image (on monitor screen) taken with the SEM or the optical microscope. Using a mouse and a cursor tool, the edge of a randomly selected fibrous element is sought and then measured across its width (i.e., perpendicular to fibrous element direction at that point) to the other edge of the fibrous element. A scaled and calibrated image analysis tool provides the scaling to get actual reading in μm. For fibrous elements within a fibrous structure, several fibrous element are randomly selected across the sample of the fibrous structure using the SEM or the optical microscope. At least two portions of the fibrous structure are cut and tested in this manner.

Altogether at least 100 such measurements are made and then all data are recorded for statistical analysis. The recorded data are used to calculate average (mean) of the fibrous element diameters, standard deviation of the fibrous element diameters, and median of the fibrous element diameters.

Another useful statistic is the calculation of the amount of the population of fibrous elements that is below a certain upper limit. To determine this statistic, the software is programmed to count how many results of the fibrous element diameters are below an upper limit and that count (divided by total number of data and multiplied by 100%) is reported in percent as percent below the upper limit, such as percent below 1 micrometer diameter or %-submicron, for example. We denote the measured diameter (in μm) of an individual circular fibrous element as di.

In the case that the fibrous elements have non-circular cross-sections, the measurement of the fibrous element diameter is determined as and set equal to the hydraulic diameter which is four times the cross-sectional area of the fibrous element divided by the perimeter of the cross-section of the fibrous element (outer perimeter in case of hollow fibrous elements). The number-average diameter, alternatively average diameter is calculated as:

$${d}_{num} = \frac{{\sum }_{i = 1}^{n} {d}_{i}}{n}$$

### Median Particle Size Test Method

This test method must be used to determine median particle size, which, as used herein, refers to the volume weighted mean particle size.

Particle size is measured using an Accusizer 780A, made by Particle Sizing Systems, Santa Barbara Calif. The instrument is calibrated from 0 to 300 μm using Duke particle size standards. Samples for particle size evaluation are prepared by diluting about 1 g emulsion, if the volume weighted mean particle size of the emulsion is to be determined, or 1 g of capsule slurry, if the finished capsule volume weighted mean particle size is to be determined, in about 5 g of de-ionized water and further diluting about 1 g of this solution in about 25 g of water.

About 1 g of the most dilute sample is added to the Accusizer and the testing initiated, using the autodilution feature. The Accusizer should be reading in excess of 9200 counts/second. If the counts are less than 9200 additional sample should be added. The accusizer will dilute the test sample until 9200 counts/second and initiate the evaluation. After 2 minutes of testing the Accusizer will display the results, including volume-weighted median size.

The broadness index can be calculated by determining the particle size at which 95% of the cumulative particle volume is exceeded (95% size), the particle size at which 5% of the cumulative particle volume is exceeded (5% size), and the median volume-weighted particle size (50% size-50% of the particle volume both above and below this size).

Broadness Index (5)=((95% size)−(5% size)/50% size).

### Basis Weight Test Method

Basis weight of a fibrous structure is measured on stacks of twelve usable units using a top loading analytical balance with a resolution of ±0.001 g. The balance is protected from air drafts and other disturbances using a draft shield. A precision cutting die, measuring 3.500 in±0.0035 in by 3.500 in±0.0035 in may be used to prepare the samples.

With a precision cutting die of suitable size, cut the samples into squares. Combine the cut squares to form a stack twelve samples thick. Measure the mass of the sample stack and record the result to the nearest 0.001 g.

The Basis Weight is calculated in lbs/3000 ft² or g/m² as follows:

Basis Weight=(Mass of stack)/[(Area of 1 square in stack)×(No. of squares in stack)]

Report result to the nearest 0.1 lbs/3000 ft² or 0.1 g/m². Sample dimensions can be changed or varied using a similar precision cutter as mentioned above, so as at least 100 square inches of sample area in stack.

### Edge Seal Breadth

For a given unit dose article, randomly select five locations of the flange of the edge seal. Measure and record the linear distance across the seal on the specimen (identified as seal dimension “X” in FIG. 2 of ASTM F88/F88M-09) to the nearest 0.1 mm. Report the statistical mean of the five measurements as the edge seal breadth.

### EXAMPLES

The examples provided below are intended to be illustrative in nature and are not intended to be limiting.
Example 1. A plurality of water-soluble unit dose articles according to the present disclosure is provided, where a first article comprises a first perfume, and a second article comprises a second perfume that is different from the first perfume. The first and second articles are substantially the same size and shape, but the first article includes a different color and/or graphical indicia compared to the color and/or graphical indicia of the second article.
Example 2. A plurality of water-soluble unit dose articles according to the present disclosure is provided, where a first article is relatively smaller than a second article. The first and second articles have the same general quadrilateral shape, but the both the length (about 10 cm) and width (about 8 cm) of the first article are less than the corresponding length (about 5 cm) and width (about 4 cm), respectively, of the second article.
Example 3. A plurality of water-soluble unit dose articles according to the present disclosure is provided. The first article comprises anionic surfactant and is useful as a detergent in the wash cycle of an automatic washing machine. The second article comprises a quaternary ammonium softening compound but is free of anionic surfactant; the second article is useful as a fabric softener in a rinse cycle of an automatic washing machine. Both articles include graphical indicia; the first article has a first brand logo (e.g., TIDE™), and the second article has a second, different brand logo (e.g., DOWNY™). The articles also comprise complementary shapes, where the shape of the first article can tessellate with the shape of the second article. The first and second articles can be used sequentially in a regimen or process of treating a fabric.
Example 4. A plurality of water-soluble unit dose articles according to the present disclosure is provided. Both first and second unit dose articles comprise anionic surfactant, but only the second article includes a peroxygen-forming bleaching agent. Both articles include graphical indicia; the first article has a first brand logo (e.g., GAIN™), and the second article has a second, different brand logo (e.g., TIDE OXI™).
Example 5. A plurality of water-soluble unit dose articles according to the present disclosure is provided. A first article comprises neat perfume and perfume encapsulates and features a graphical indicia in the form of a flower. A second article is free of perfume and perfume encapsulates, and features a graphical indicia in the form of a baby.
Example 6. A single container is provided and contains any of the pluralities of articles described in Examples 1-5.
Example 7. A plurality of containers is provided, where any of the first articles of Examples 1-5 are contained in a first container, and where any of the second articles of Examples 1-5 are contained in a second container. The first and second container maybe co-packaged in secondary packaging, or the first and second containers may be separate but on a shelf, for example of a store or of a consumer.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A plurality of water-soluble unit dose articles, the plurality comprising at least a first article and a second article,
each article comprising at least a first ply, the first ply comprising a plurality of fibrous elements, each fibrous element comprises at least one filament-forming material and optionally a surfactant,
wherein the plurality comprises a compositional difference between the first and second articles, and
wherein the plurality comprises a physical difference between the first and second articles.

2. A plurality of water-soluble unit dose articles according to claim 1, wherein the compositional difference relates to at least one active agent selected from surfactant, perfume, one or more bleaching agents, enzymes, a polymeric dispersing agent, a soil release polymer, a fabric hueing agent, a fluorescent brightener, a dye transfer inhibiting agent, a hygiene or malodor agent, a conditioning or softening agent, or mixtures thereof.

3. A plurality of water-soluble unit dose articles according to claim 2, wherein the compositional difference relates to a level of the active agent.

4. A plurality of water-soluble unit dose articles according to claim 3, wherein the first article comprises the active agent at a higher concentration level compared to the concentration level of the active agent in the second article.

5. A plurality of water-soluble unit dose articles according to claim 2, wherein the active agent is present in the first article but not the second article, or is present in the second article but not the first article.

6. A plurality of water-soluble unit dose articles according to claim 1, wherein the physical difference relates to a feature selected from the group consisting of size, shape, color, graphical indicia, texture, basis weight, and combinations thereof.

7. A plurality of water-soluble unit dose articles according to claim 6, wherein the physical difference relates to size, wherein the first article is relatively larger than the second article.

8. A plurality of water-soluble unit dose articles according to claim 6, wherein the physical difference relates to shape.

9. A plurality of water-soluble unit dose articles according to claim 8, wherein the first and second articles each have a shape, where the shape of the first article is physically complementary to the shape of the second article.

10. A plurality of water-soluble unit dose articles according to claim 6, wherein the physical difference relates to color.

11. A plurality of water-soluble unit dose articles according to claim 6, wherein the physical difference relates to graphical indicia.

12. A plurality of water-soluble unit dose articles according to claim 1, wherein the first and second articles are co-located in a container.

13. A plurality of water-soluble unit dose articles according to claim 1, wherein the plurality further comprises a third article,
wherein the plurality comprises a compositional difference between the first, second, and third articles, and
wherein the plurality comprises a physical difference between the first, second, and third articles.

14. A plurality of water-soluble unit dose articles according to claim 1, wherein the first article and/or the second article are characterized by:
a length of no greater than 15 cm, or no greater than 12 cm, or no greater than 10 cm,
optionally the length being no less than 3 cm, no less than 4 cm, or no less than 5 cm, or no less than 6 cm, and
having a ratio of the perimeter to the area of the shape defined by the perimeter (“perimeter:area ratio”) in the range of from 3:10 cm⁻¹, or from 4:10 cm⁻¹, to no greater than 12:10 cm⁻¹ (e.g., 1.2 cm⁻¹), or no greater than 10:10 cm⁻¹, or no greater than 8:10 cm⁻¹, or no greater than 6:10 cm⁻¹.

15. A process for treating a surface, the process comprising the steps of:
contacting the surface with water in which a first water-soluble unit dose article has been dissolved,
contacting the surface with water in which a second water-soluble unit dose article has been dissolved,
wherein the first and second articles each comprise at least a first ply, the first ply comprising a plurality of fibrous elements, each fibrous element comprises at least one filament-forming material and optionally a surfactant,
wherein the first and second articles are characterized by a compositional difference, and
wherein the first and second articles are characterized by a physical difference.

16. A process according to claim 15, wherein the compositional difference relates to at least one active agent selected from surfactant, perfume, one or more bleaching agents, enzymes, a polymeric dispersing agent, a soil release polymer, a fabric hueing agent, a fluorescent brightener, a dye transfer inhibiting agent, a hygiene or malodor agent, a conditioning or softening agent, or mixtures thereof.

17. A process according to claim 16, wherein the at least one active agent comprises perfume.

18. A process according to claim 15, wherein the physical difference relates to a feature selected from the group consisting of size, shape, color, graphical indicia, texture, basis weight, and combinations thereof.

19. A process according to claim 15, wherein the physical difference relates to color, graphical indicia, or both.

20. A process according to claim 15, wherein the first and second articles are dissolved in the same water.

21. A process according to claim 15, wherein the surface is a fabric.
